(19) United States
(12) Patent Application Publication
(10) Pub. No.: US 2020/0128078 A1
(43) Pub. Date: Apr. 23, 2020

(54) METHODS, APPARATUS, AND SYSTEMS FOR MONITORING WIRELESS FLUID PROPERTY SENSORS

(71) Applicant: Luke David Cyca, Vancouver (CA)

(72) Inventor: Luke David Cyca, Vancouver (CA)

(21) Appl. No.: 16/708,422

(22) Filed: Dec. 9, 2019

Related U.S. Application Data
(60) Provisional application No. 62/749,229, filed on Oct. 23, 2018.

(51) Int. Cl. H04L 29/08; G01N 9/36; G01K 1/02; H04W 4/38; H04Q 9/00

(52) U.S. Cl. CPC H04L 67/12; G01N 9/36; H04Q 2209/43; H04W 4/38; H04Q 9/00; G01K 1/024

(57) ABSTRACT

The present embodiments relate generally to methods, apparatus, and systems for remotely monitoring data from fluid property sensors contained within a fluid vessel. A transceiver receives data from one or more fluid property sensors and transmits them to a receiver for transmission to a server and display on a client device. The transceiver may connect to an existing port on a fluid vessel or be fully contained within the vessel. These embodiments provide a reliable, convenient, and cost-effective means for remotely monitoring fluid properties, such as monitoring a fermentation profile.

### FIELD

This invention relates to monitoring wireless sensors. Particular embodiments provide apparatus and methods for monitoring wireless fluid property sensors located within vessels.

### BACKGROUND

Continuous, reliable measurement of fluid processes like fermentation is advantageous but may be difficult to achieve using current technology.

For example, it is desirable to monitor the fermentation process of beer and other alcoholic beverages. The fluid density or specific gravity can be measured to indicate the initiation, rate, and cessation of fermentation. Monitoring the fermentation process may provide a brewer an opportunity to correct or modify unexpected or undesirable results. Monitoring the brewing process can also provide the brewer an indication of when the fermentation process has finished, improving the utilization of manufacturing resources.

Conventionally, specific gravity is measured by taking a sample of the product and using a glass hydrometer. There are several disadvantages to this approach. The measurement is a manual process requiring a user to be present and is also susceptible to user error. There are also several disadvantages of requiring a test sample. The sample is typically discarded, so taking more frequent measurements increases the amount of wastage. In addition, the process of taking the sample may increase the risk of contamination.

There are a variety of measurement devices in the prior art. For example, radioactive detectors can be used to measure fluid density. The systems can be extremely expensive, complex, and/or highly regulated. They may also require extensive infrastructure.

Simpler, more cost-effective devices also exist. For example, U.S. Pat. No. 9,234,828 describes a free-floating, wireless device for measuring specific gravity and temperature. The sensor is designed to be used in small vessels and requires a suitable wireless receiver to be in close proximity. This can be inconvenient and may not work reliably in larger vessels, or vessels made of material that interfere with wireless transmission. Furthermore, the system is limited in the number of sensors that can be used simultaneously within a given proximity.

There remains a need for a reliable, convenient, and cost-effective method for remotely monitoring wireless fluid property sensors. Specifically, there remains a need to monitor and control multiple wireless fluid property sensors remotely.

### SUMMARY

The invention has a number of different aspects that have synergy when combined but are also capable of application individually and/or in subcombinations. These aspects include, without limitation:

A transceiver for receiving data from a sensor inside a vessel and retransmitting the data outside the vessel using a wired or wireless communication link.

Another aspect provides a system for remotely monitoring data from one or more wireless sensors.

Another aspect provides a method for remotely monitoring data from one or more wireless sensors.

The methods and systems described herein may provide a simple, convenient, and cost-effective way to reliably monitor sensor data remotely.

### BRIEF DESCRIPTION OF THE DRAWINGS

The accompanying drawings illustrate non-limiting example embodiments of the invention.

FIG. 1 is a schematic diagram of a system for reading from a wireless sensor within a vessel and transmitting to a user device according to at least one embodiment of the present disclosure;

FIG. 2 is a schematic diagram of a system for reading from a wireless sensor within a vessel and transmitting to a user device according to at least one embodiment of the present disclosure;

FIG. 3 is a block diagram of a method for remotely monitoring a (wireless) sensor according to at least one embodiment of the present disclosure;

FIG. 4 is an illustration of a transceiver for reading from a wireless sensor within a vessel and transmitting to an external receiver according to at least one embodiment of the present disclosure;

FIG. 5 is a perspective view of a sensor transceiver according to at least one embodiment of the present disclosure;

FIG. 6 is a perspective view of a sensor transceiver according to at least one embodiment of the present disclosure;

FIG. 7 is an exploded view of a sensor transceiver according to at least one embodiment of the present disclosure;

FIG. 8 is an cross sectional view of a sensor transceiver attached to a fluid vessel according to at least one embodiment of the present disclosure;

FIG. 9 is a graph illustrating an example fermentation profile according to at least one embodiment of the present disclosure; and

FIG. 10 is an example screenshot of a fermentation profile measured from a wireless sensor according to at least one embodiment of the present disclosure.

### DETAILED DESCRIPTION

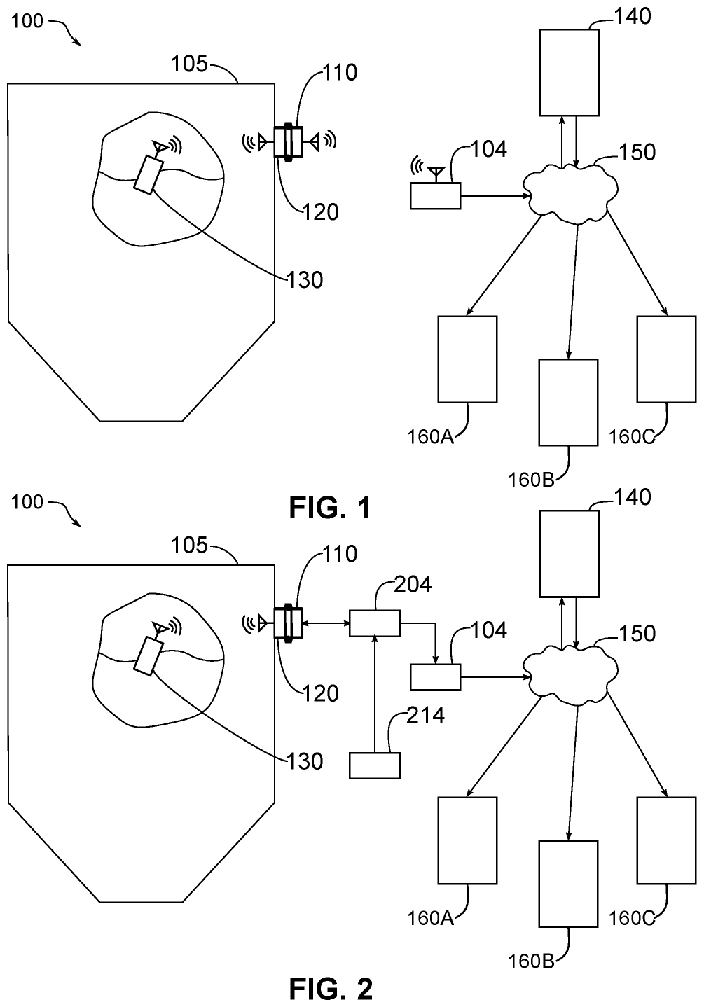

Referring to FIG. 1, shown there generally as 100 is a schematic diagram of a system for remotely monitoring data from a wireless sensor contained in a fluid vessel 105 according to at least one embodiment of the present disclosure. System 100 may include one or more sensors 130 located within one or more vessels 105, a transceiver 110, a receiver (web connector) 104, server 140 and one or more client devices (illustrated here, for example, as 170A, 170B and 170C.)

System 100 may include one or more sensors 130 contained within a vessel 105. Sensors 130 may be configured to acquire one or more measurements. Sensors 130 may transmit the measurements to a transceiver 110. Transceiver 110 may receive the measurements from one or more sensors 130 and transmit the measurement to receiver 104. Receiver 104 may transmit the sensor data to server 140 via a network 150.

Transceiver 110 may be configured to operate as a repeater or as a transmitter-receiver. In a repeater configuration, transceiver 110 may simply receive and transmit data received from the sensor to boost signal strength. Alternatively, or in addition, transceiver 110 may be configured to operate as transmitter-receiver. In this configuration, transceiver 110 may receive data from sensor 130 using a first communication protocol and transmit data to receiver 104 using a second communications protocol. For example, transceiver 110 may receive data using a BLUETOOTH® receiver and transmit data using a WI-FI™ transmitter.

In some embodiments, transceiver 110 may include one or more external antennas inside the vessel or outside the vessel. In some embodiments, transceiver 110 may include one or more cables for power or communications.

Receiver 104 may be a router or other device capable of receiving data and transmitting it to network 150. Receiver 104 may be a wireless or wired device.

Server 140 may be connected to the internet and/or intranet. Server 140 may connect to a database to store measurement data. Server 140 may perform processing to transform or augment measurement data.

Client devices 160A-C may be a computer, a smartphone, a tablet, or any other conventionally known or future developed communication device capable of illustrating data from the sensor.

For example, sensor 140 may be a sensor for measuring the specific gravity of a fluid within the vessel such as the TILT™ sensor from Baron Brew Equipment. The Tilt is a wireless, free-floating sensor for measuring specific gravity and temperature. The device periodically transmits measurement data via Bluetooth.

Referring to FIG. 2, shown there generally as 200 is a schematic diagram of a system for remotely monitoring fluid sensors according to at least one embodiment of the present disclosure.

In some embodiments, system 100 may also include additional components. For example, system 100 may include a Power over Ethernet (POE) injector 204 and a power supply 214 to provide power to transceiver 110.

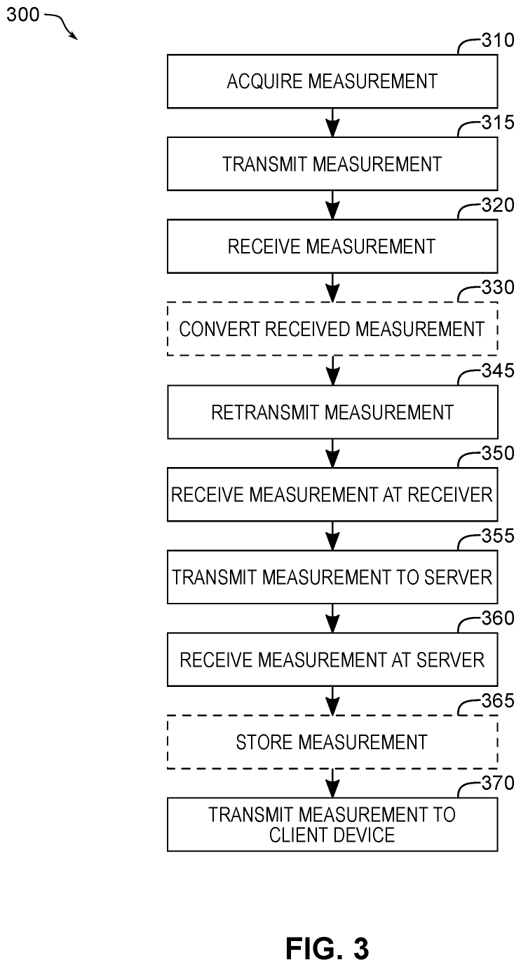

Referring to FIG. 3, shown there generally as 300 is a block diagram illustrating acts of a method for remotely monitoring sensor data.

At 310, sensor 130 acquires one or more measurements. Sensor 130 may acquire several measurements over a period of time and may calculate an average or other statistical measure. Sensor 130 may also acquire measurements from one or more sensors. Sensor 130 may use data from one or more sensor to calibrate the data from another sensor. For example, sensor 130 may acquire pH and temperature measurements.

At 315, sensor 130 transmits one or more data transmissions. The data transmission may include at least one of a sensor measurement, a sensor identification number and a timestamp. The data transmissions may also include additional sensor status data such as battery life and/or signal strength.

At 320, one or more data transmission are received by transceiver 110.

In some embodiments, at optional act 330, transceiver 110 may convert the one or more received sensor measurements from a first format to a second format. In some embodiments, transceiver 110 may append additional data to the one or more received sensor measurements. For example, transceiver 110 may append an identification ID associated with the transceiver device.

At 345, transceiver device 110 may retransmit the sensor data packet. The sensor data packet may be transmitted in the same format or may be in a different format.

At 350, receiver 104 receives the sensor data packet.

At 355, receiver 104 transmits the sensor data packet to the server 140 via network 150. The sensor data packet may be transmitted using a Wi-Fi connection, ethernet, fiber optic, or cellular

At 360, server 140 receives the sensor data packet.

At 365, server 140 may store the sensor data packet.

At 370, server 140 transmits the sensor data packet to one or more client devices.

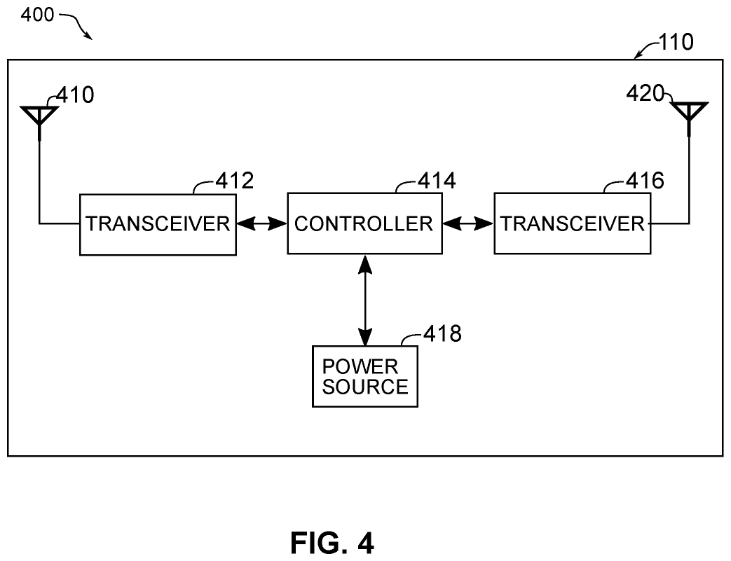

Referring to FIG. 4, shown there generally as 400, is an illustration of a transceiver 110 for reading from a wireless sensor within a vessel and transmitting to an external receiver according to at least one embodiment of the present disclosure.

Transceiver 110 may be connected to a first antenna 410 for communicating inside the vessel. Transceiver 110 may be connected to a second antenna 420 for communicating outside the vessel.

Transceiver 110 may include a first transceiver 412 and second transceiver 416. First transceiver 412 may be a Bluetooth communication interface. Second transceiver 416 may be a Wi-Fi communication interface.

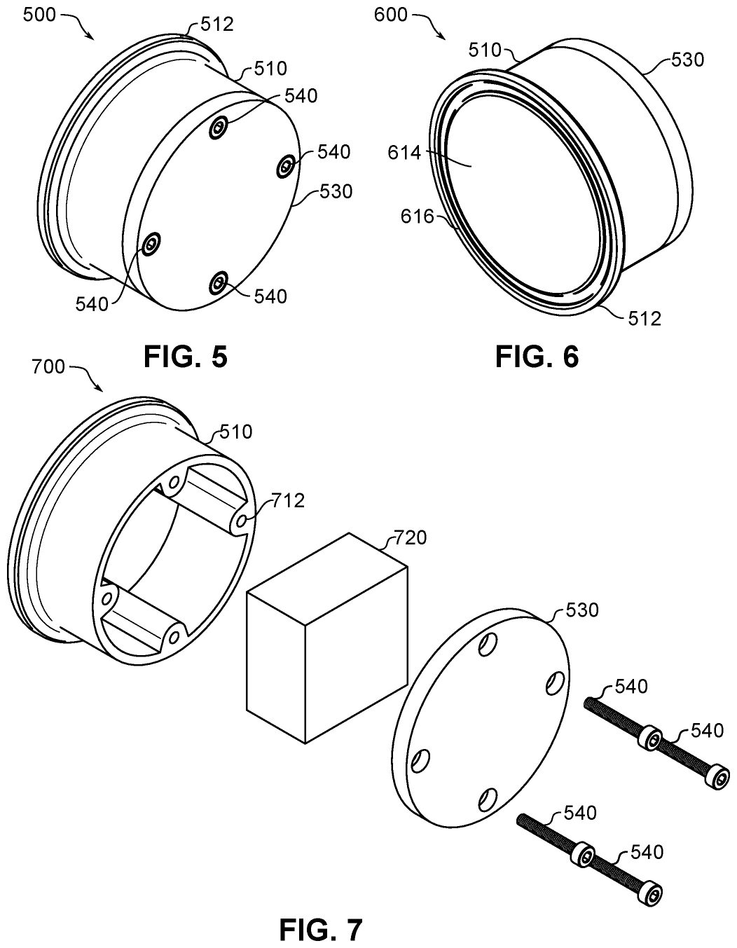

Referring to FIG. 5, shown there generally as 500 is an illustration of a sensor transceiver 510 according to at least one embodiment of the present disclosure.

Transceiver 510 may be powered internally by a battery or powered externally via a cable.

An interface portion 512 of transceiver enclosure 510 may be formed in a shape such that the transceiver is able to attach to a standard port on a vessel. In a preferred embodiment, interface portions 512 may be shaped to conform to ISO 2852-1993 Stainless steel clamp pipe couplings for the food industry, commonly referred to as a Tri-Clover style port. Alternatively or in addition, the interface may be configured to conform to 3-A Sanitary Standards. Being shaped in a manner compatible with standard vessel ports provides several advantages. Interfacing with a standard vessel ports provides for easy installation and makes it easy to move the transceiver between multiple vessels.

Referring to FIG. 6, shown there generally as 600 is an isometric view of a sensor transceiver in accordance with at least one embodiment of the present disclosure.

Transceiver 510 may include an interface surface 614. Interface surface 614 may be comprised of a material that allows for the transmission of radio waves. For example, interface surface 614 may be comprised of ultra high molecular weight polyethylene (UHMWPE) plastic, or any other conventionally known or future developed materials that are substantially radio transparent. The interface material may also be selected to be sanitary.

In some embodiments, the entire body of the transceiver may be constructed from a material that is substantially radio transparent and sanitary.

Referring to FIG. 7, shown there generally as 700 is an exploded view of a sensor transceiver according to at least one embodiment of the present disclosure. Transceiver 510 may include a main body 514, internal enclosure 720 and lid 530.

Internal enclosure 720 may house electronics and power sources. For example, internal enclosure 720 may include a first communication interface 412 and second communication interface 416. Internal enclosure 720 may also include a battery.

Referring simultaneously to FIG. 5-7, in some embodiments, lid 530 is affixed to the main body using one or more fasteners 540. Lid 530 may be attached in a variety of other manners. For example, lid 530 may use threads to attach to main body 514. The connection between lid 530 and main body 514 may be designed such that connected enclosure is resistant to ingress from dust and water. For example, main body 512, or lid 530 or both may incorporate an O-ring to provide a seal.

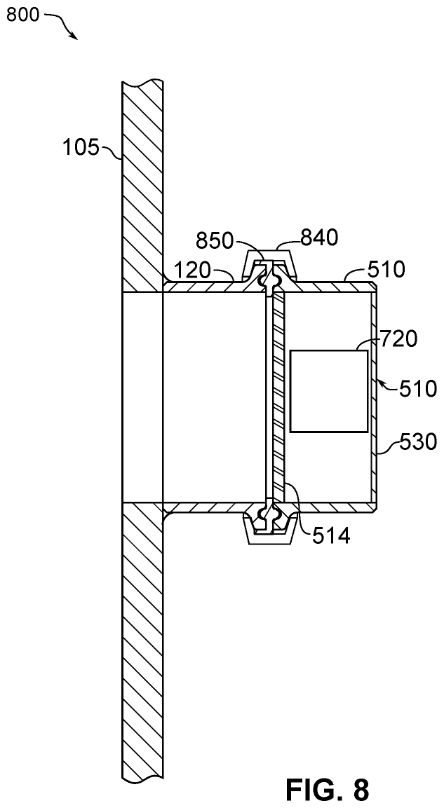

Referring to FIG. 8, shown there generally as 800, is a cross sectional view of a sensor transceiver attached to a fluid vessel according to at least one embodiment of the present disclosure.

Sensor transceiver 510 may be mounted to a vessel connection 120 of vessel 105. Transceiver 510 may be secured to vessel 105 using a gasket 850 and clamp 840.

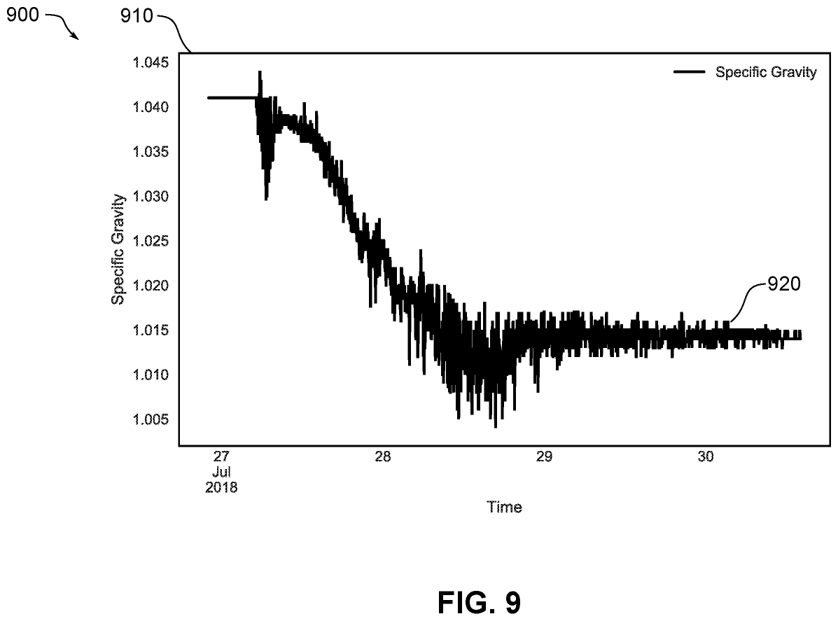

Referring to FIG. 9, shown there generally as 900, is a graph illustrating an example fermentation profile according to at least one embodiment of the present disclosure. Example graph 910 illustrates an example time series 920 of measurements of a fermentation process. In this example, time series 920 consists of a time series of specific gravity measurements.

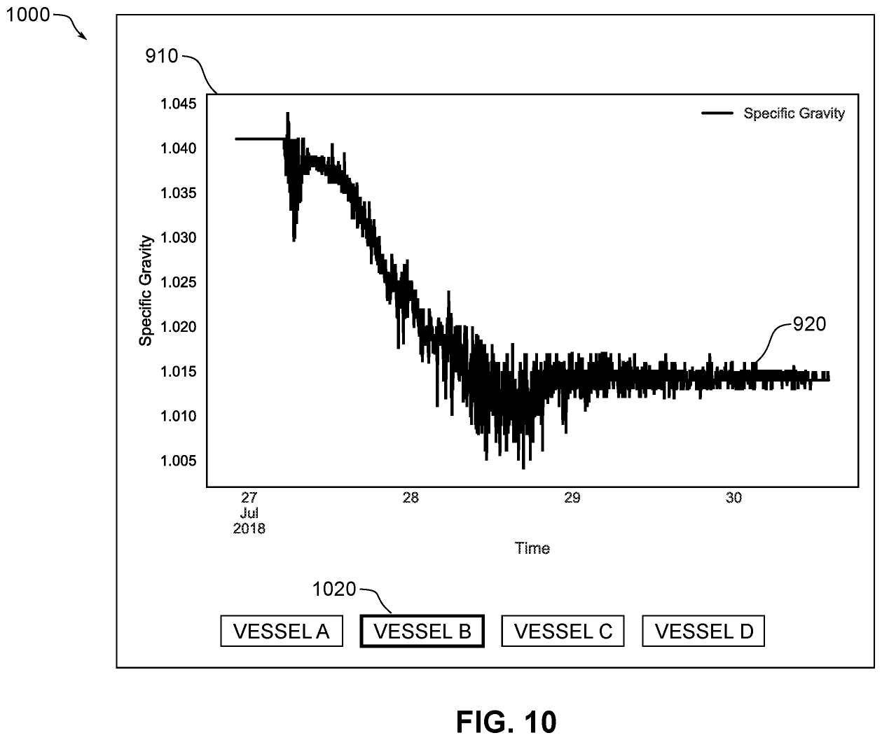

Referring to FIG. 10, shown there generally as 1000, is an example screenshot of a fermentation profile measured from a wireless sensor according to at least one embodiment of the present disclosure. The screenshot may include a graph 910 with a time series 920 of measurements. One or more time series may be displayed simultaneously. The screenshot may represent what is viewable on the display of a client device in communication with server 140.

In some embodiments, a user may select to view the time series 920 from one or more vessels by choosing control 1020.

In some embodiments, the graph 910 may include multiple types of measurements. For example, graph 910 may include specific gravity and temperature.

The sensor transceiver 110 described herein may provide an affordable, reliable means for measuring sensor data from within a vessel and conveying that data to make it available on a client device. This may provide a convenient system to monitor various parameters of a fluid contained within one or more vessels. For example, a brewer may use one or more sensor transceivers 110 to monitor the fermentation process using a wireless sensor.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Unless the context clearly requires otherwise, throughout the description and the claims:

Words that indicate directions such as “vertical”, “transverse”, “horizontal”, “upward”, “downward”, “forward”, “backward”, “inward”, “outward”, “vertical”, “transverse”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Embodiments of the invention may be implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in a control circuit for a device may implement methods as described herein by executing software instructions in a program memory accessible to the processors.

For example, while processes or blocks are presented in a given order herein, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

The invention may also be provided in the form of a program product. The program product may comprise any non-transitory medium which carries a set of computer-readable instructions which, when executed by a data processor (e.g., in a controller and/or ultrasound processor in an ultrasound machine), cause the data processor to execute a method of the invention. Program products according to the invention may be in any of a wide variety of forms. The program product may comprise, for example, non-transitory media such as magnetic data storage media including floppy diskettes, hard disk drives, optical data storage media including CD ROMs, DVDs, electronic data storage media including ROMs, flash RAM, EPROMs, hardwired or preprogrammed chips (e.g., EEPROM semiconductor chips), nanotechnology memory, or the like. The computer-readable signals on the program product may optionally be compressed or encrypted.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

It is therefore intended that the following appended claims and claims hereafter introduced are interpreted to include all such modifications, permutations, additions, omissions, and subcombinations as may reasonably be inferred. The scope of the claims should not be limited by the preferred embodiments set forth in the examples but should be given the broadest interpretation consistent with the description as a whole.

What is claimed is:

1. A system for wirelessly monitoring at least one fluid property of a fluid contained within a fluid vessel, the system comprising:
at least one fluid property sensor, wherein the fluid property sensor is configured to acquire at least one fluid property measurement and wirelessly transmit said fluid property measurement using a first communication protocol, wherein the first communication protocol is a wireless communication protocol;
a transceiver, configured to receive the at least one fluid property measurement using the first communication protocol and transmit the at least one fluid property measurement using a second communication protocol;
a server, configured to receive the at least one fluid property measurement; and
at least one client device, configured to receive the at least one fluid property measurement.

2. The system of claim 1, wherein the first communication protocol is selected from the group consisting of Bluetooth and Wi-Fi,

3. The system of claim 1 wherein the second communication protocol is selected from the group consisting of Ethernet, Bluetooth, Wi-Fi, and cellular.

4. The system of claim 1, wherein the at least one fluid property measurement is a measurement of the specific gravity of the fluid in the pressure vessel.

5. The system of claim 1, wherein the at least one fluid property measurement is selected from the group consisting of pH and temperature.

6. The system of claim 1, wherein the system further comprises:
a receiver, configured to receive the at least one fluid property measurement from the first transceiver using the second communication protocol and transmit the at least one fluid property measurement to the server using a third communication protocol.

7. A wireless transceiver comprising:
a transceiver, comprising a first communication interface connected to a second communication interface, wherein the first communication interface is configured to communicate with at least one fluid property sensor contained within a fluid vessel using a first wireless communication protocol, and wherein the second communication interface is configured to communicate with a receiver located outside of the fluid vessel using a second communication protocol; and
an enclosure to house the transceiver.

8. The wireless transceiver of claim 7, wherein the first wireless communication protocol is selected from the group consisting of Bluetooth and Wi-Fi.

9. The wireless transceiver of claim 7, wherein the enclosure comprises a portion configured to maintain a sealed connection with the fluid vessel.

10. The wireless transceiver of claim 7, wherein the enclosure is configured to attach to an existing port on the fluid vessel.

11. The wireless transceiver of claim 7, wherein energy is provided to power the first communication interface and the second communication interface using a battery.

12. The wireless transceiver of claim 7, wherein energy is provided to power the first communication interface and the second communication interface through a Power over Ethernet connection.

13. The wireless transceiver of claim 7, wherein the wireless transceiver is located entirely within the fluid vessel.

14. A method for monitoring one or more fluid property sensors contained within a pressure vessel, the method comprising:
acquiring at least one fluid property measurement using at least one fluid property sensor; wherein the at least one fluid property sensor is contained within a fluid vessel;
transmitting the at least one fluid property measurement from the at least one fluid property sensor using a first communication protocol;
receiving the at least one fluid property measurement using a transceiver;
transmitting, from the transceiver, the at least one fluid property measurement using a second communication protocol;
receiving, at a server, the at least one fluid property measurement; and
transmitting, from the server, the at least one fluid property to a client device.

15. The method of claim 13, wherein the first communication protocol is selected from a group consisting of Bluetooth and Wi-Fi.

16. The method of claim 13, wherein the method further comprises:
converting the at least one fluid property measurement received using the first transceiver from a first format to a second format.

17. The method of claim 13, wherein the method further comprises:
storing at least two of the at least one fluid property measurement on the server.

18. The method of claim 13, wherein the method further comprises:
receiving, at a receiver, the at least one fluid property measurement transmitted from the transceiver using the second communication protocol; and
transmitting, from the receiver, the at least one fluid property measurement using a third communication protocol to the server.

19. The method of claim 13, wherein the at least one fluid property measurement comprises a measure of specific gravity of the fluid in the fluid vessel.

20. The method of claim 19, wherein the client device displays two or more fluid property measurements to display a fermentation profile.
